(19) United States
(12) Patent Application Publication
(10) Pub. No.: US 2005/0042964 A1
(43) Pub. Date: Feb. 24, 2005

(54) Fiber laminate and method of making same

(75) Inventors: Sebastian Sommer, Troisdorf (DE); Bernd Kunze, Hennef (DE)

Correspondence Address: THE FIRM OF KARL F ROSS, 5676 RIVERDALE AVENUE, PO BOX 900, RIVERDALE (BRONX), NY, 10471-0900, US

(73) Assignee: Reifenhauser GmbH & co. Maschinenfabrik

(21) Appl. No.: 10/912,739

(22) Filed: Jul. 30, 2004

(30) Foreign Application Priority Data
Aug. 20, 2003 (EP) 03018909.6

(51) Int. Cl. B32B 5/26; D04H 1/00; D04H 1/56; D04H 3/16; D04H 3/00

(52) U.S. Cl. 442/382; 442/401; 442/400; 442/389; 442/415; 442/414

(57) ABSTRACT

A fiber laminate, especially an absorbent wiping cloth, wherein at least one layer of a spun-bonded web and at least one layer of meltblown fibers is provided. Furthermore, at least one layer of hydrophilic fibers is present. Some of the meltblown fibers are also distributed in the layer of spun-bonded web and/or in the layer of the hydrophilic fibers.

### FIELD OF THE INVENTION

Our present invention relates to a fiber laminate, especially an absorbent wiping cloth, comprising at least one layer of a spun-bond web and at least one layer of hydrophilic fibers. The invention also relates to a method for manufacturing such a fiber laminate. The term “fiber laminate” means a multilayer product or a laminate comprising a plurality of fiber layers. The spun-bond web consists of filaments. The term “filaments” means continuous fibers, i.e. theoretically infinitely long threads from which the spun-bond web is formed. Within the scope of the invention filaments means especially filaments of a thermoplastic synthetic resin and particularly thermoplastic monofilament.

### BACKGROUND OF THE INVENTION

A method is known from practice with which absorbent textile structures, also designated as wiping cloths, are produced. In this case, fibers of a thermoplastic synthetic resin are mixed with hydrophilic or water-absorbent fibers. The first fibers can, for example, comprise filaments or fibers of polypropylene or polyethylene terephthalate (PET). The second hydrophilic fibers comprise, for example, cellulose fibers. The fiber mixture is carded as part of the known measures and then water-jet needled or hydraulically solidified. The wiping cloths produced using this known method have only a relatively low elasticity. After deformation of the wiping cloth, barely any elastic restoring forces occur and there is normally no appreciable shape restoration. Furthermore, these known wiping cloths always exhibit symmetrical behavior with regard to their liquid permeability or liquid absorption capacity. That is, there properties are identical on both sides, i.e. towards the top and towards the bottom of the wiping cloth. However, that is not always desired.

### OBJECTS OF THE INVENTION

It is an object of the invention to provide a fiber laminate, especially a wiping cloth, which has exceptional elastic properties and which, when required, can also be asymmetrical with regard to the liquid permeability and absorption capacity.

Another object is to provide a method for manufacturing such a fiber laminate.

### SUMMARY OF THE INVENTION

These objects are achieved with a fiber laminate, especially an absorbent wiping cloth, wherein at least one layer of a spun-bond web and at least one layer of meltblown fibers are provided and at least one layer of hydrophilic fibers is present. According to the invention some of the meltblown fibers are distributed in the layer of spun-bond web and/or in the layer of the hydrophilic fiber.

A spun-bond web according to the invention consists of filaments and is appropriately manufactured using a spun-bond method. It is within the scope of the invention that the meltblown fibers comprise continuous meltblown fibers. Hydrophilic fibers means within the scope of the invention water-absorbent fibers. Especially cellulose fibers such as, for example, pulp fibers or viscose fibers can be used as hydrophilic fibers. The layer of hydrophilic fibers forms an absorbent layer in the fiber laminate according to the invention. The fact that some of the meltblown fibers are also distributed in the layer of spun-bond web and/or in the layer of hydrophilic fibers means within the scope of the invention that at least some of the meltblown fibers enter into the intermediate spaces at least of one of said layers. As is explained further below, the meltblown fibers are preferably transferred into said layers in the course of the compaction or the hydrodynamic compaction of the layer aggregate.

If subsequently preferred layers of the fiber laminate according to the invention are described, the respectively uppermost layer of the fiber laminate comprises the layer which is oriented upwards during the further processing or treatment of the fiber laminate. Thus, if the fiber laminate is subjected to water-jet solidification or compaction acting from above, the uppermost layer is acted upon as the first layer by the water jets.

It is within the scope of the invention that the layer of meltblown fibers is arranged on the layer of spun-bond web and the layer of hydrophilic fibers is deposited on the layer of meltblown fibers. More Appropriately in this case, the layer of meltblown fibers lies directly on the layer formed by the spun-bond web and the layer of hydrophilic fibers preferably lies directly on the layer of meltblown fibers.

According to a special embodiment of the invention, a second layer of meltblown fibers can be applied to the layer of hydrophilic fibers. According to a very preferred embodiment of the invention, a further layer of a spun-bond web is arranged on the layer of hydrophilic fibers. If this layer of spun-bond web is applied directly to the layer of hydrophilic fibers, this is a fiber laminate with asymmetric behavior (spun bond web/meltblown fiber layer/hydrophilic fiber layer/spun-bond web). That is, the liquid permeability or liquid absorption capacity is different on both sides (top and bottom) of the fiber laminate.

The invention is in this case based on our discovery that the layer of meltblown fibers which is merely adjacent to spun-bond web layer impedes or restricts the liquid permeability. This asymmetric behavior of such a fiber laminate is desired in many cases. However, it is also within the scope of the invention that the further layer of meltblown fibers is arranged on the layer of hydrophilic fibers with a further layer of meltblown fibers inserted in between. A fiber laminate with symmetrical behavior is then obtained (spun-bond web/meltblown fiber layer/hydrophilic fiber layer/meltblown fiber layer/spun-bond web). The liquid permeability or liquid absorption capacity is then identical or at least very similar on both sides top and bottom) of the fiber laminate.

According to another embodiment of the invention, the fiber laminate consists of first layer of a spun-bond web and a layer of hydrophilic fibers applied directly thereon. Adjacent to this layer of hydrophilic fibers is the layer of meltblown fibers. A second layer of a spun-bond web can be applied to this last layer of meltblown fibers.

It is within the scope of the invention that the meltblown fibers used consist at least of one elastomer. An elastomer comprises a material or plastic which is rubber-elastic at room temperature. Elastic meltblown fibers are thus used. According to an especially preferred embodiment, the elastic meltblown fibers consist of at least one elastomer from the group which consists of “polyurethane and ethylene-propylene-diene-mixed polymerisate (EPDM). It is within the scope of the invention that a fiber laminate according to the invention contains 3 to 15 wt. %, preferably 5 to 10 wt. % meltblown fibers.

The invention furthermore teaches a method for manufacturing a fiber laminate, especially an absorbent wiping cloth, wherein at least one layer of a spun-bond web of filaments is formed, wherein at least one layer of meltblown fibers is applied, and wherein in addition, at least one layer of hydrophilic fibers is applied and wherein the resulting layer aggregate is solidified to form the fiber laminate and specifically is solidified subject to the condition that the meltblown fibers from the meltblown fiber layer penetrate into at least one adjacent layer of spun-bond web and/or hydrophilic fibers. It is within the scope of the invention that during the solidification or consolidation meltblown fibers are transferred into at least one adjacent layer only on one side (top or more appropriately bottom) of the meltblown layer or on both sides. In any case, meltblown fibers are transferred into the layer directly adjacent to this side of the meltblown fiber layer. This directly adjacent layer preferably comprises a spun-bond web layer. It is within the scope of the invention that at least a part of the layers of the fiber laminate is pre-solidified or precompacted. According to one embodiment, only the layer of the spun-bond web can be pre-solidified or pre-consolidate. According to another embodiment, the aggregate of the spun-bond web layer and the meltblown fiber layer is pre-solidified. The pre-solidification can thus take place before applying the layer of meltblown fibers or after applying this meltblown fiber layer. This pre-solidification is preferably carried out using a calender for example. The hydrophilic fiber are appropriately applied using a card and/or with the aid of an air-layering device.

After combining of the layers, the resulting layer aggregate is consolidated to give a fiber laminate. The term “solidification” here means the final consolidation. According to a very preferred embodiment of the invention, the layer aggregate is hydrodynamically solidified. In this case, it is within the scope of the invention that the fiber laminate is hydrodynamically consolidated by water-jet treatment. In such a water-jet solidification or water-jet needling fine, very fast water jets or high-pressure water jets solidify the fiber laminate. As a result of this hydrodynamic solidification meltblown fibers are pressed or pushed from the meltblown fiber layer and into the adjacent layer. This has the consequence that after the solidification or final solidification some of the meltblown fibers are present in at least one layer adjacent to the meltblown fiber layer.

During the normal manufacture of spun-bond web or web laminates using conventional raw materials such as polyolefins and polyesters, elastic products or products with elastic restoring properties cannot easily be manufactured. However, the invention is based on the knowledge that in a fiber laminate according to the invention, elastic properties can be adjusted in a simple fashion by incorporating meltblown fibers or elastic meltblown fibers into the laminate in the manner according to the invention. The elastic properties of the fiber laminate acquire quite particular importance within the scope of the invention. According to the invention, it is possible to produce an absorbent or water-absorbent wiping cloth which is additionally distinguished by an excellent elasticity. The elasticity is in this case achieved with the meltblown fibers incorporated in the fiber laminate. As has already been described above, in a fiber laminate according to the invention symmetrical or asymmetric properties with regard to the liquid permeability or liquid absorption capacity can be advantageously adjusted as required.

### BRIEF DESCRIPTION OF THE DRAWING

The above and other objects, features, and advantages will become more readily apparent from the following description, reference being made to the accompanying drawing in which:

FIG. 1 is a schematic diagram showing a section through a fiber laminate according to the invention with asymmetric properties; and

FIG. 2 is a section through a laminate with symmetrical properties; and

FIG. 3 is a diagram illustrating the method.

### SPECIFIC DESCRIPTION

The fiber laminate shown in FIG. 1 consists of a first layer 1 of a spun-bond web of filaments. Applied directly to this is a first layer 2 of meltblown fibers 8. Adjacent to this layer 2 of meltblown fibers 8 is a layer 3 of hydrophilic fibers. A second layer 4 of a spun-bond web is applied to this layer 3. This fiber laminate exhibits asymmetric behavior with regard to the water permeability or water absorption capacity. This means that the water permeability or water absorption capacity is different with reference to the top 5 and with reference to the bottom 6 of the fiber laminate.

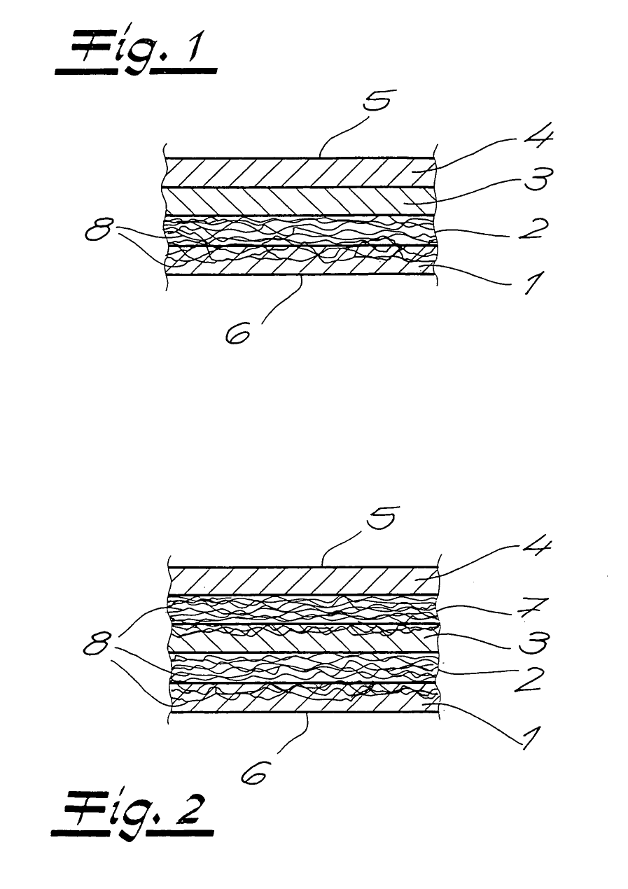

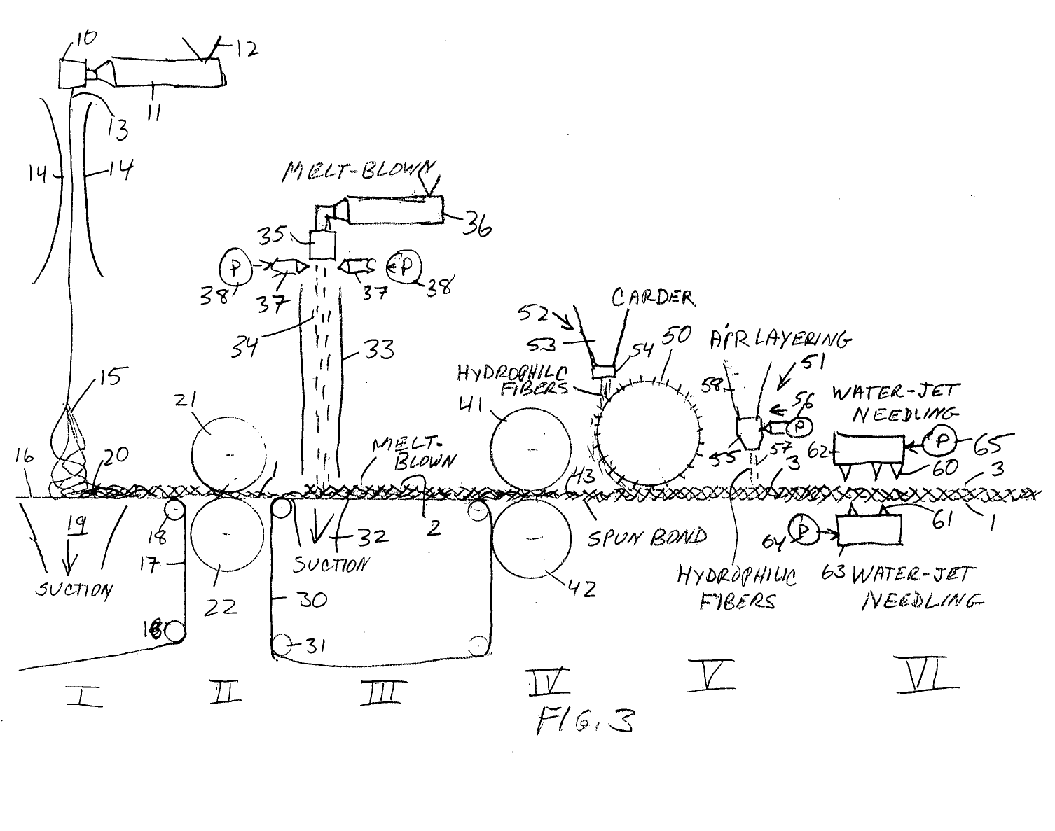

The fiber laminate in FIG. 2 on the other hand comprises a symmetrical fiber laminate. In this case, a second layer 7 of meltblown fibers 8 is located on the layer 3 of hydrophilic fibers. A second layer 4 of spun-bond web is applied to his said layer 7.

It has also been indicated in FIGS. 1 and 2 that meltblown fibers 8 are located in the intermediate spaces of the layer 1 of spun-bond web and in FIG. 2 they are also located in intermediate spaces of the layer 3 of hydrophilic fibers. These meltblown fibers 8 originate from the layer 2 or 7 of meltblown fibers 8 located thereabove. During manufacture of the fiber laminate shown in FIGS. 1 and 2 meltblown fibers 8 were inserted or pressed into the layer 1 or 3 during the hydrodynamic solidification. According to a preferred embodiment of the invention the layer 1 of spun-bond web and/or the layer 3 of hydrophilic fibers contains more than 1 wt. %, preferably more than 2 wt. % of meltblown fibers 8 (wt. % data is only related to the layer 1 of spun-bond web or to the layer 3 of hydrophilic fibers).

That nonwoven fabric can be made, for example, with an apparatus of the type shown diagrammatically in FIG. 3. The apparatus of FIG. 3 comprises a spun bond stage I followed by a precompaction stage II, a melt blown stage III, a further compaction stage IV, a stage V in which the hydrophilic fibers are deposited upon the melt blown/spun bond laminate, and a hydrodynamic needling or consolidation stage VI at which, by the use of water jet needling, melt blown fibers can be caused to penetrate into the hydrophilic fibers are above or into the spun bond layer there below. At the end of stage VI, any of the stages earlier in the sequence can be repeated, for example, to deposit another spun bond and/or melt blown and/or hydrophilic fiber layer.

In the spun bond stage I, a Spaniard 10 can be supplied with a thermoplastic synthetic resin by a worm-type plastifier unit 11 having a hopper 12 into which the granular thermoplastic is fed. The curtain of plastic filaments 13 descends through an aerodynamic stretching unit symbolized by the curved walls 14 and the aerodynamically stretch and monofilaments 15 are collected in a jumble upon a foraminous surface 16 of an endless perforated belt 17 passing over rolls 18 and a suction chamber 19. The mat 20 of monofilaments which collect on the surface 16 has the filaments bonded together at the filament crossovers at the elevated temperature of the monofilaments and is thus a spun-bond nonwoven mat. This mat may be presolidified or compacted between a pair of calender rolls 21 and 22, together forming a calender of stage II. The compressed product is the spun bond layer 1 previously described which is delivered to stage III.

In stage III, the layer 1 can be again supported on a perforated belt 30 passing over rollers 31 and across the mouth of a suction chamber 32 below a shaft 33 through which melt blown fibers 34 descend onto the layer 1 to form a layer 2 of the melt blown fibers.

The fibers 34 are generated on the underside of the Spaniard 35 supplied with the molten thermoplastic from a worm extruder 36 by air jets from nozzles 37 which cut off the fibers as they emerge from the Spaniard 35. The nozzles 37 are supplied with compressed air from the air compressors 38.

The layers of melt blown fibers 2 and spun bond 1 pass through a calendar forming stage IV and thus between calender rolls 41 and 42 to produce the melt blown/spun bond laminate 43.

As has been described previously, to this laminate, a layer of hydrophilic fibers 3 can be applied (stage V) either from a card, in this case a carding drum 50 or by an air lying unit 51, or both. The hydrophilic fibers may be fed to the card 50 in the card 50 in the card unit 52 by a hopper 53 and a metering device 54. Alternatively, the air layering unit 51 can include a nozzle 55 through which air from a compressor 56 may entrain the hydrophilic fibers 57 from a hopper 58 onto the laminate 43.

The hydrodynamic consolidation is effected in stage VI by water jets trained on the resulting laminate by needling nozzles 60 and 61 above and below the laminate. The nozzles 60 and 61 are connected to manifolds 62 and 63 which extend the full width of the laminate web, i.e. perpendicular to the plane of the paper of FIG. 3 and can be connected to high pressure water pumps 64, 65. The water jet needling carries melt blown fibers from the layer 2 into the layers 1 and 3 there below and there above, respectively.

The resulting product can be used directly as an absorbent wiping cloth and the web can be subdivided for that purpose or additional layers can be added (see FIG. 2) by repetition of the stages I through VI selectively as described.

1. A fiber laminate comprising:
at least one layer of a spun-bond web;
at least one meltblown layer comprised of meltblown fibers; and
at least one layer of hydrophilic fibers, at least some of said meltblown fibers from said meltblown layer being distributed in at least one of the other layers.

2. The fiber laminate defined in claim 1 wherein said meltblown layer is on said layer of said spun-bond web.

3. The fiber laminate defined in claim 2 wherein some of said meltblown fibers are distributed in said layer of said spun-bond web.

4. The fiber laminate defined in claim 3 wherein some of said meltblown fibers are distributed in said layer of hydrophilic fibers.

5. The fiber laminate defined in claim 4 wherein at least one further layer of a spun-bond web is provided on said layer of hydrophilic fibers.

6. The fiber laminate defined in claim 1 wherein said meltblown fibers are comprised at least in part of at least one elastomer.

7. The fiber laminate defined in claim 6 wherein said elastomer is selected from the group which consists of polyurethane and EPDM rubber.

8. A method of making a fiber laminate which comprises the steps of:
(a) forming a layer of a spun-bond web;
(b) applying to said layer of said spun-bond web, a meltblown layer of meltblown fibers;
(c) additionally providing at least one layer of hydrophilic fibers to form a layer aggregate; and
(d) consolidating said layer aggregate in such manner as to distribute meltblown fibers from said meltblown layer in at least one other of said layers.

9. The method defined in claim 8, further comprising the step of precompacting at least one of said layer of spun-bond web and said meltblown layer.

10. The method defined in claim 9 wherein said layer aggregate is hydrodynamically consolidated.

11. The method defined in claim 8 wherein said layer aggregate is hydrodynamically consolidated.

12. The method defined in claim 8 wherein said layer aggregate in such manner as to distribute meltblown fibers from said meltblown layer in both of the others of said layers.

13. The method defined in claim 12 wherein said layer aggregate is needled through by water jets from at least one side.
